(19) United States
(12) Patent Application Publication
(10) Pub. No.: US 2020/0064954 A1
(43) Pub. Date: Feb. 27, 2020

(54) TOUCH PANEL AND METHOD THEREOF

(71) Applicant: Wuhan China Star Optoelectronics Semiconductor Display Technology Co.,Ltd., Wuhan (CN)

(72) Inventor: Caiqin CHEN, Wuhan (CN)

(73) Assignee: Wuhan China Star Optoelectronics Semiconductor Display Technology Co.,Ltd., Wuhan (CN)

(21) Appl. No.: 16/308,466

(22) PCT Filed: Sep. 13, 2018
(86) PCT No.: PCT/CN2018/105358

§ 371 Date: Dec. 9, 2018

(30) Foreign Application Priority Data
Aug. 21, 2018 (CN) 2018109554518.7

(51) Int. Cl. G06F 3/047; G06K 9/00; G06F 3/044; G06F 3/0488

(52) U.S. Cl. CPC G06F 3/047; G06F 3/04886; G06F 3/044; G06K 9/00087

(57) ABSTRACT

A touch panel and a method thereof are provided. The touch panel comprises a touch layer. The touch layer includes a fingerprint identification area and a touch area. The first switch coupled to the first signal receiving terminal turns off/on when the first signal receiving terminal in the fingerprint identification area receives the low voltage/the high voltage output by the first input terminal. The fingerprint identification area is configured to identify a fingerprint pattern or a touch operation.

### BACKGROUND

### 1. Field of the Disclosure

The present disclosure relates to the panel manufacturing technology, and more particularly, to a touch panel and a touch method for the touch panel.

### 2. Description of the Related Art

At present, fingerprint identification has become one of the basic configurations of a cellphone. Two common designs for fingerprint identification are coating of cellphone's back and using of cellphone's front cover. A fingerprint identification area is set on the back of the cellphone or the lower area of the cellphone screen.

The basic principle of capacitive fingerprint identification is to collect fingerprints by numerical variations in capacitance. A human fingerprint has irregular lines; for example, the ridge of the fingerprint is convex, and the valley of the fingerprint is concave. Different capacitive values are produced with fingerprints' ridges and valleys in a fingerprint identification area when user's finger contacts the display screen. The locations of the ridges and the valleys can be sensed according to the discharging speed of different capacitors. With detection of the differences of the electric current, fingerprint pattern data are gathered.

The popularity of a cellphone with a comprehensive screen brings forth an application of the screen fingerprint technology. The fingerprint identification area and the touch area are two separate areas in the related art. In business markets where the demand for cellphone screens is increasing, the technique of the related art is no longer competitive. Besides, it needs more money to design the fingerprint identification area and the touch area at the same time.

In light of this, the present disclosure provides a technical plan to resolve the above-mentioned technical problem.

### SUMMARY

The present disclosure proposes a touch panel and a touch method for the touch panel to resolve the technical problems that the touch panel screen of the related art is small and that the cost of setting a fingerprint identification area is high.

According to a first aspect of the present disclosure, a method for detecting a contact on a device comprises: providing a touch panel comprising a touch layer that comprises a fingerprint identification area; disconnecting a first switch coupled to a first signal receiving terminal when the first signal receiving terminal in the fingerprint identification area receives high voltage/low voltage output by a first input terminal; the fingerprint identification area receiving a fingerprint identification signal output by a second input terminal; the fingerprint identification area configured to identify a fingerprint pattern; turning the first switch coupled to the first signal receiving terminal off when the first signal receiving terminal in the fingerprint identification area receives the low voltage/the high voltage output by the first input terminal; the fingerprint identification area receiving a touch signal output by a third input terminal; the fingerprint identification area configured to identify a touch operation.

Optionally, the fingerprint identification further comprises first-array signal lines configured to acquire a capacitive value of each capacitive dot array in the fingerprint identification area to obtain a minutiae of a fingerprint pattern, or the first-array signal line configured to acquire the capacitive value of each of the capacitive dot arrays in the fingerprint identification area and variation of the capacitive value to obtain a touch location.

Optionally, the touch layer comprises a touch area that comprises second-array signal lines configured to acquire the capacitive value of each of the capacitive dot arrays in the touch area and the variation of the capacitive value to obtain the touch location.

Optionally, the touch panel further comprises a second signal receiving terminal, a fourth input terminal, and a second switch. The second switch coupled to the second signal receiving terminal is turned off when the second signal receiving terminal in the fingerprint identification area receives high voltage/low voltage output by the fourth input terminal; the fingerprint identification area receives a touch signal output by a third input terminal; the fingerprint identification area is configured to identify a touch operation; the second switch coupled to the second signal receiving terminal is disconnected when the second signal receiving terminal in the fingerprint identification area receives the low voltage/the high voltage output by the fourth input terminal; the fingerprint identification area receives a fingerprint identification signal output by the second input terminal; the fingerprint identification area is configured to identify the fingerprint pattern.

According to second aspect of the present disclosure, a touch panel comprising a touch layer is provided. The touch layer comprises a fingerprint identification area and a touch area. The fingerprint identification comprises first-array signal lines. The first-array signal lines are configured to acquire a capacitive value of each capacitive dot array in the fingerprint identification area to obtain a minutiae of a fingerprint pattern, or the first-array signal lines are configured to acquire the capacitive value of each of the capacitive dot arrays in the fingerprint identification area and variation of the capacitive value to obtain a touch location. The touch area comprises second-array signal lines. The second-array signal lines are configured to acquire the capacitive value of each of the capacitive dot arrays in the touch area and the variation of the capacitive value to obtain the touch location.

Optionally, the touch panel further comprises a second signal receiving terminal, a fourth input terminal, and a second switch. The second switch coupled to the second signal receiving terminal is turned off when the second signal receiving terminal in the fingerprint identification area receives high voltage/low voltage output by the fourth input terminal. The fingerprint identification area receives a touch signal output by a third input terminal. The fingerprint identification area is configured to identify a touch operation. The second switch coupled to the second signal receiving terminal is disconnected when the second signal receiving terminal in the fingerprint identification area receives the low voltage/the high voltage output by the fourth input terminal. The fingerprint identification area receives a fingerprint identification signal output by the second input terminal. The fingerprint identification area is configured to identify the fingerprint pattern.

Optionally, the fingerprint identification area may be shaped as a circle, a square, a rectangle, or an ellipse.

Optionally, the fingerprint identification area comprises a first electrode block. The first electrode block is configured to identify the fingerprint pattern. The first electrode block is configured to acquire the capacitive value of each of the capacitive dot arrays in the fingerprint identification area to obtain the minutiae of the fingerprint pattern or the touch location. The touch area comprises a second electrode block. The second electrode block is configured to acquire the capacitive value of each of the capacitive dot arrays in the touch area and the variation of the capacitive value to obtain the touch location. The first electrode block corresponds to one or more pixel opening. The area occupied by the second electrode block is greater than the area occupied by the first electrode block. The first electrode block and the second electrode block are both transparent electrodes.

Optionally, the ratio of the touch area to the fingerprint identification area is n; the n is greater than zero.

According to a third aspect of the present disclosure, a touch panel comprising a touch layer is provided. The touch layer comprises a fingerprint identification area and a touch area. The fingerprint identification comprises first-array signal lines. The first-array signal lines are configured to acquire a capacitive value of each capacitive dot array in the fingerprint identification area to obtain a minutiae of a fingerprint pattern, or the first-array signal lines are configured to acquire the capacitive value of each of the capacitive dot arrays in the fingerprint identification area and variation of the capacitive value to obtain a touch location. The touch area comprises second-array signal lines. The second-array signal lines are configured to acquire the capacitive value of each of the capacitive dot arrays in the touch area and the variation of the capacitive value to obtain the touch location. A density of the first array lines are greater than a density of the second-array signal lines.

Optionally, the touch panel further comprises a second signal receiving terminal, a fourth input terminal, and a second switch. The second switch coupled to the second signal receiving terminal is turned off when the second signal receiving terminal in the fingerprint identification area receives high voltage/low voltage output by the fourth input terminal. The fingerprint identification area receives a touch signal output by a third input terminal. The fingerprint identification area is configured to identify a touch operation. The second switch coupled to the second signal receiving terminal is disconnected when the second signal receiving terminal in the fingerprint identification area receives the low voltage/the high voltage output by the fourth input terminal; the fingerprint identification area receives a fingerprint identification signal output by the second input terminal. The fingerprint identification area is configured to identify the fingerprint pattern.

Optionally, the fingerprint identification area may be shaped as a circle, a square, a rectangle, or an ellipse.

Optionally, the fingerprint identification area comprises a first electrode block. The first electrode block is configured to identify the fingerprint pattern. The first electrode block is configured to acquire the capacitive value of each of the capacitive dot arrays in the fingerprint identification area to obtain the minutiae of the fingerprint pattern or the touch location. The touch area comprises a second electrode block. The second electrode block is configured to acquire the capacitive value of each of the capacitive dot arrays in the touch area and the variation of the capacitive value to obtain the touch location. The first electrode block corresponds to one or more pixel opening. The area occupied by the second electrode block is greater than the area occupied by the first electrode block. The first electrode block and the second electrode block are both transparent electrodes.

Optionally, the ratio of the touch area to the fingerprint identification area is n; the n is greater than zero.

The beneficial effects of the present disclosure are as follows: The process of fabricating a touch panel becomes very simple because the fingerprint identification area is set as an area for time-division multiplexing of fingerprint identification and touch operation, and the fingerprint identification area and the touch area are arranged at the same layer. The fingerprint identification area is disposed in the same layer as the touch area, which simplifies the process of manufacturing the touch panel, saves production cost, and reduces the thickness of the display device.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a touch panel according to a first embodiment of the present disclosure.

FIG. 2 illustrates a schematic diagram of the touch panel operated in a fingerprint identification stage according to the first embodiment of the present disclosure.

FIG. 3 illustrates a schematic diagram of the touch panel operated in a touch stage according to the first embodiment of the present disclosure.

FIG. 4 is a schematic diagram of a touch panel according to a second embodiment of the present disclosure.

FIG. 5 illustrates a schematic diagram of the touch panel operated in a fingerprint identification stage according to the second embodiment of the present disclosure.

FIG. 6 illustrates a schematic diagram of the touch panel operated in a touch stage according to the second embodiment of the present disclosure.

FIG. 7 illustrates another schematic diagram of the touch panel operated in the touch stage according to the second embodiment of the present disclosure.

FIG. 8 illustrates a flowchart of a method of detecting a contact on the touch panel according to a third embodiment of the present disclosure.

### DETAILED DESCRIPTION OF THE EMBODIMENTS

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

The embodiment provides a touch panel. The touch panel includes a touch layer. The touch layer includes a fingerprint identification area and a touch area. The touch area is disposed at the periphery of the fingerprint identification area.

In the touch panel of the present disclosure, the fingerprint identification area includes first-array signal lines. The first-array signal lines are configured to acquire a capacitive value of each capacitive dot array in the fingerprint identification area to obtain the minutiae of user's fingerprint pattern. Or, the first-array signal lines are configured to acquire a capacitive value of each capacitive dot array in the fingerprint identification area and variation of the capacitive value to obtain a touch location.

In other words, when the fingerprint identification area is configured to identify the fingerprint pattern, the ridge and valley of user's finger and the first-array signal lines in the fingerprint identification area define different capacitive values. According to discharging speeds of different capacitors, the difference in electric current can be sensed so that the locations of the ridge and the valley can be sensed to define fingerprint pattern data. The fingerprint identification area is configured to perform the touch operation to obtain the touch position of user's finger based on the variation in the capacitive value generated after the finger contacts the touch panel.

In the touch panel proposed by the present disclosure, the first-array signal lines include a first-row signal line 101 and a first-column signal line 102. The first-row signal line 101 and the first-column signal line 102 are insulated and intersected. Two of the neighboring first-row signal lines 101 and two of the neighboring first-column signal lines 102 form a first opening. The first opening corresponds to one or more pixel opening.

The second-array signal lines include a second-row signal line 201 and a second-column signal line 202. The second-row signal line 201 and the second-column signal line 202 are insulated and intersected. Two of the neighboring second-row signal lines 201 and two of the neighboring second-column signal lines 202 form a second opening. The area of the second opening is greater than the area of the first opening.

The first-row signal line 101 is parallel to the second-row signal line 201. The first-column signal line 102 is parallel to the second-column signal line 202.

In the touch panel of the present disclosure, the first-row signal line 101 and the second-row signal line 201 are at the same metallic layer. The first-column signal line 102 and the second-column signal line 202 are at the same metallic layer. That is to say, the first-row signal line 101 and the second-row signal line 201 are patterned by a mask process. The first-column signal line 102 and the second-column signal line 202 are patterned by a mask process. One or more insulating layer is disposed between the first-array signal lines and the second-array signal lines which crosses the first-array signal line.

The first-array signal lines and the second-array signal lines may be at the same metallic layer. The first-row signal line 101, the first-column signal line 102, the second-row signal line 201, and the second-column signal line 202 all cross and is electrically connected to one another through a metallic bridge.

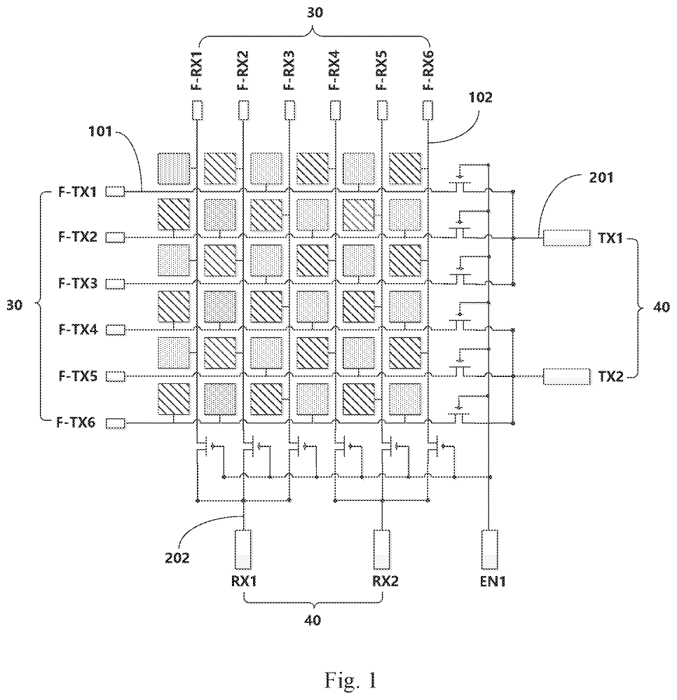

FIG. 1 is a schematic diagram of a touch panel according to an embodiment of the present disclosure. The density of the first-array signal lines is greater than the density of the second-array signal lines. Each of the second-row signal lines 201 includes one or more first-row signal line 101. Each of the second-column signal lines 202 includes one or more first-column signal line 102. Each of the second-row signal lines 201 includes three first-row signal lines 101. Each of the second-column signal lines 202 includes three first-column signal lines 102.

In the touch panel proposed by the present embodiment, the ratio of the touch area to the fingerprint identification area is n. The n is greater than zero.

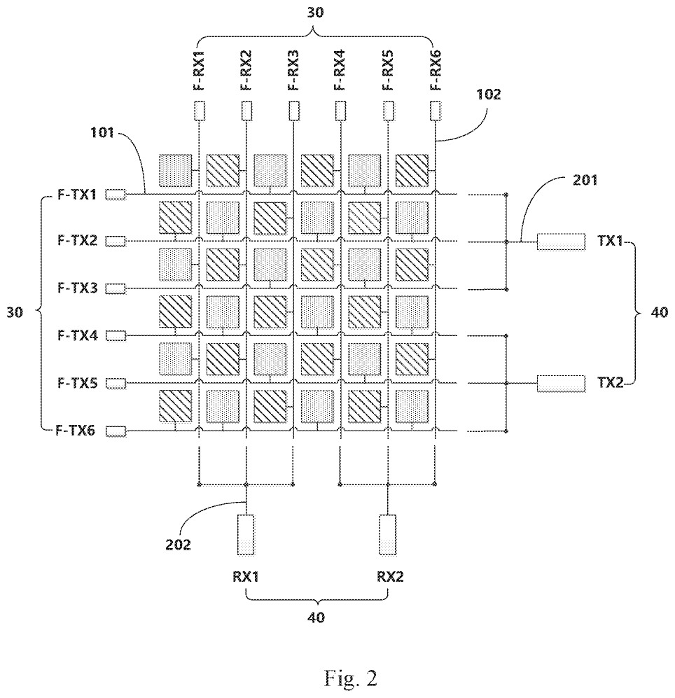

As illustrated in FIG. 2, a first switch coupled to a first signal receiving terminal is disconnected when the first signal receiving terminal in the fingerprint identification area receives high voltage/low voltage output by a first input terminal EN1. The fingerprint identification area receives a fingerprint identification signal output by a second input terminal 30. The fingerprint identification area is configured to identify user's fingerprint patterns.

The first switch coupled to the first signal receiving terminal is turned off when the first signal receiving terminal in the fingerprint identification area receives the low voltage/high voltage output by the first input terminal EN1. The fingerprint identification area receives a touch signal output by a third input terminal 40. The fingerprint identification area is configured to identify touch operations.

In this embodiment, a thin film transistor (TFT) is a p-type metal-oxide-semiconductor (PMOS). When the first signal receiving terminal in the fingerprint identification area receives the high voltage output by the first input terminal EN1, the first input terminal EN1 inputs an enabling signal. In other words, the TFT that inputs a driving signal and a sensing signal is disconnected. The fingerprint identification area receives the fingerprint identification signal output by the second input terminal 30. The fingerprint identification area is configured to identify the fingerprint. In this embodiment, the second input terminal 30 is an input fingerprint signal, that is, F-TXn and F-RXn illustrated in FIG. 2.

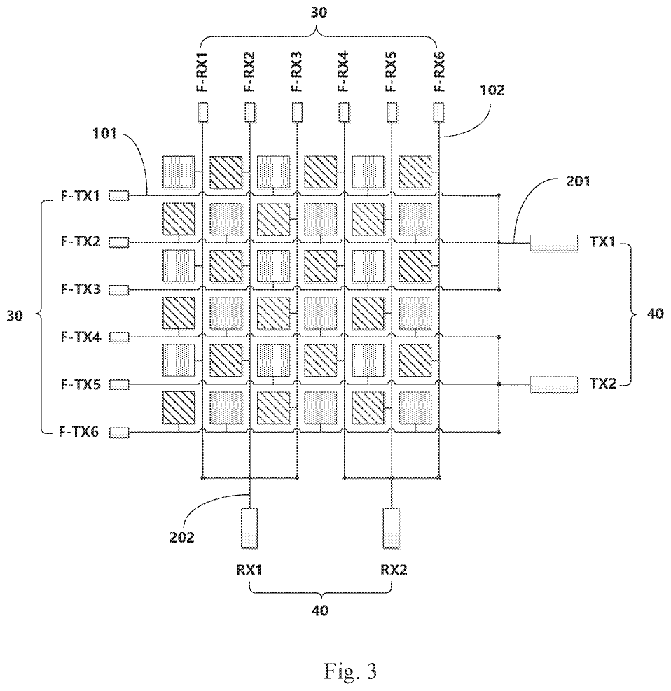

As illustrated in FIG. 3, the first switch coupled to the first signal receiving terminal is turned off when the first signal receiving terminal in the fingerprint identification area receives the low voltage outputted by the enabling signal. The fingerprint identification area receives a touch signal output by the third input terminal 40. The fingerprint identification area is configured to identify touch operations. The second input terminal 30 is TXn and RXn illustrated in FIG. 3. The first switch is a TFT where TXn and RXn are connected.

If the TFT introduced by the present disclosure is an n-type metal oxide semiconductor (NMOS), the result is opposite to the result of the present embodiment.

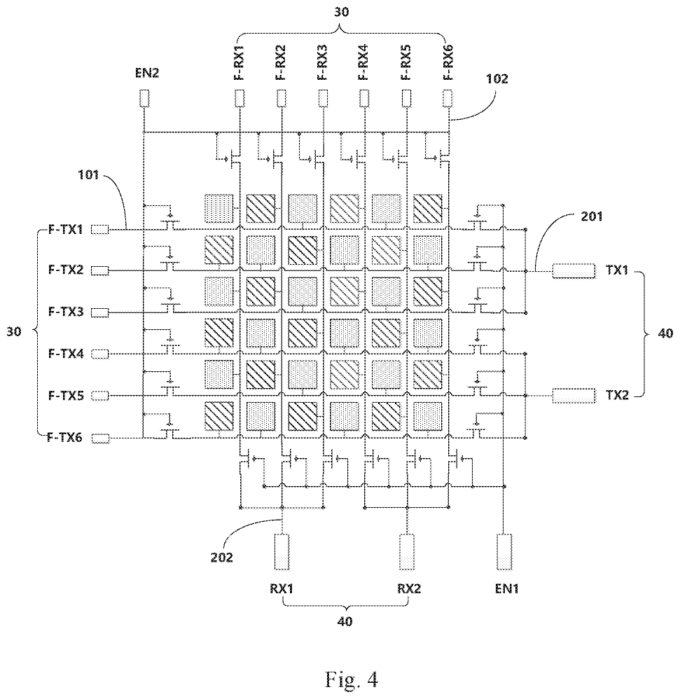

As illustrated in FIG. 4, in the touch panel proposed by the present disclosure, the touch panel further includes a second signal receiving terminal EN2 and a second switch. In another embodiment, a first switch is a p-type metal-oxide-semiconductor (PMOS), and a second switch is an n-type metal oxide semiconductor (NMOS).

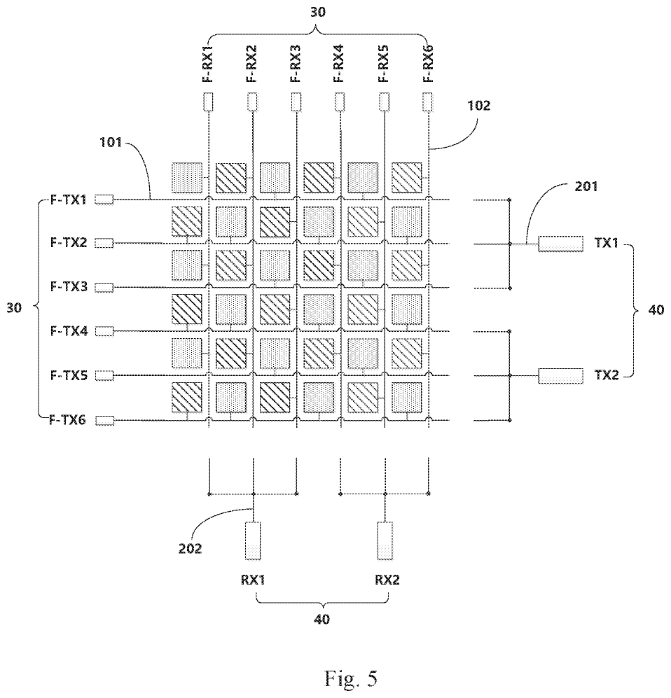

As illustrated in FIG. 5, when the second signal receiving terminal EN2 in the fingerprint identification area receives the low voltage of the second enabling signal from a fourth input terminal, and the first signal receiving terminal of the fingerprint identification area receives the low voltage output by the first input terminal EN1, the second switch connected to the second signal receiving terminal EN2 is turned off and the first switch connected to the first signal receiving terminal is disconnected. The fingerprint identification area receives the fingerprint identification signal output by the second input terminal 30. The fingerprint identification area is configured to identify the fingerprints. In this embodiment, the second input terminal 30 is F-TXn and F-RXn illustrated in FIG. 5. The second switch is a TFT where F-TXn and F-RXn are connected.

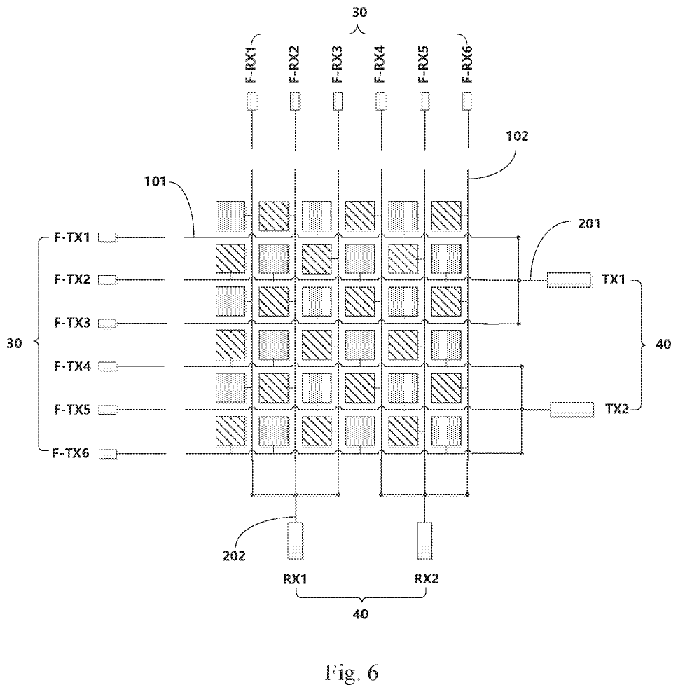

As illustrated in FIG. 6, the first signal receiving terminal in the fingerprint identification area receives high voltage output by the first input terminal EN1 when the second signal receiving terminal in the fingerprint identification area receives the high voltage output by the fourth input terminal. The second switch connected to the second signal receiving terminal EN2 is disconnected. The first switch connected to the first signal receiving terminal is turned off. The fingerprint identification area receives the touch signal output by the third input terminal 40. The fingerprint identification area is configured to identify touch operations. The second input terminal 30 is TXn and RXn illustrated in FIG. 6.

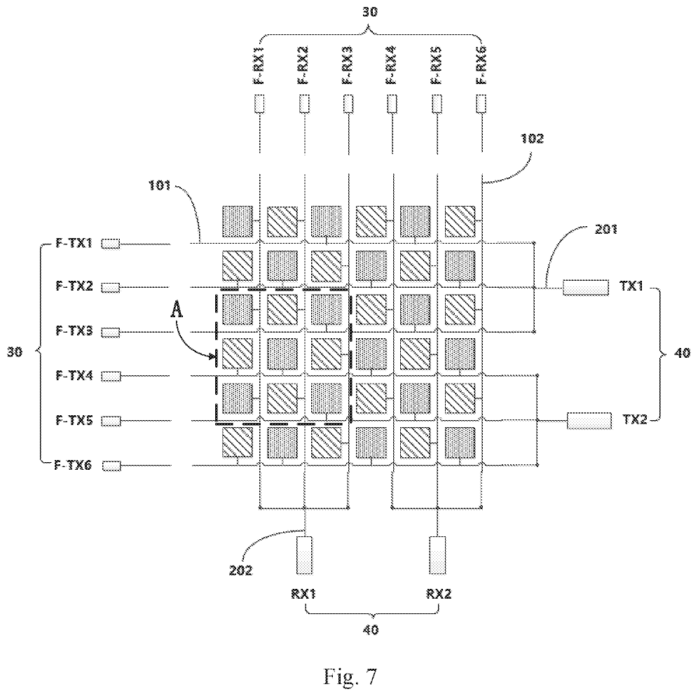

In addition, in the touch panel of the present disclosure, the fingerprint identification area may be shaped as a circle, a square, a rectangle, or an ellipse. As illustrated in FIG. 7, an area A is the fingerprint identification area, and the area excluding the area A is the touch area. When the area A receives the high voltage or the low voltage so as to disconnect the first-array signal lines, the area A is configured to receive the touch signal for touch operations.

In another embodiment of the present disclosure, a fingerprint identification area may include a first electrode block. The first electrode block is configured to identify fingerprint patterns. The first electrode block is configured to acquire a capacitive value of each capacitive dot array in a fingerprint identification area to obtain the minutiae of the fingerprint patterns or touch locations. The touch area includes a second electrode block. The second electrode block is configured to identify touch locations and acquire a capacitive value of each the capacitive dot array in the touch area and variation of the capacitive value to obtain touch locations.

The first electrode block corresponds to one or more pixel opening. The area occupied by the second electrode block is greater than the area occupied by the first electrode block. The first electrode block and the second electrode block are both transparent electrodes.

In the touch panel of the present disclosure, the fingerprint identification area further includes a fingerprint identification sensor and touch sensors (not illustrated). Each of the touch sensors is electrically connected to one or more of the fingerprint identification sensors.

In this embodiment, each of the fingerprint identification sensors receives a fingerprint signal transmitted through the first-array signal lines when the fingerprint identification area is at the fingerprint identification stage. When the fingerprint identification area is at the touch stage, the touch sensor located in the fingerprint identification area is electrically connected to three of the fingerprint identification sensors and receives a touch signal transmitted from the first-array signal lines corresponding to the three fingerprint identification sensors.

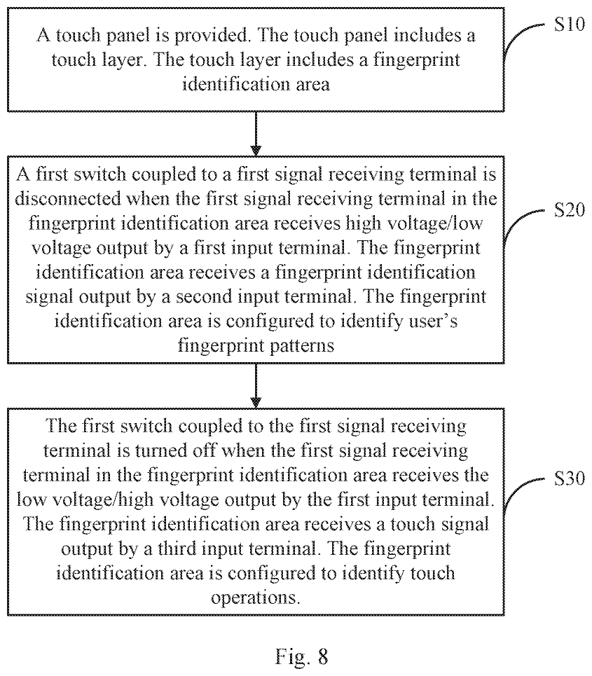

FIG. 8 is a schematic diagram showing blocks of a touch method according to an embodiment of the present disclosure. The touch method includes block S10, block S20, and block S30.

At block S10, a touch panel is provided. The touch panel includes a touch layer. The touch layer includes a fingerprint identification area.

At block S20, a first switch coupled to a first signal receiving terminal is disconnected when the first signal receiving terminal in the fingerprint identification area receives high voltage/low voltage output by a first input terminal. The fingerprint identification area receives a fingerprint identification signal output by a second input terminal. The fingerprint identification area is configured to identify user's fingerprint patterns.

At block S30, the first switch coupled to the first signal receiving terminal is turned off when the first signal receiving terminal in the fingerprint identification area receives the low voltage/high voltage output by the first input terminal. The fingerprint identification area receives a touch signal output by a third input terminal. The fingerprint identification area is configured to identify touch operations.

Optionally, the fingerprint identification further comprises first-array signal lines configured to acquire a capacitive value of each capacitive dot array in the fingerprint identification area to obtain a minutiae of a fingerprint pattern, or the first-array signal lines configured to acquire the capacitive value of each of the capacitive dot arrays in the fingerprint identification area and variation of the capacitive value to obtain a touch location.

Optionally, the touch layer comprises a touch area that comprises second-array signal lines configured to acquire the capacitive value of each of the capacitive dot arrays in the touch area and the variation of the capacitive value to obtain the touch location.

Optionally, the touch panel further comprises a second signal receiving terminal, a fourth input terminal, and a second switch. The second switch coupled to the second signal receiving terminal is turned off when the second signal receiving terminal in the fingerprint identification area receives high voltage/low voltage output by the fourth input terminal. The fingerprint identification area receives a touch signal output by a third input terminal. The fingerprint identification area is configured to identify a touch operation. The second switch coupled to the second signal receiving terminal is disconnected when the second signal receiving terminal in the fingerprint identification area receives the low voltage/the high voltage output by the fourth input terminal. The fingerprint identification area receives a fingerprint identification signal output by the second input terminal; the fingerprint identification area is configured to identify the fingerprint pattern.

According to the present disclosure, the process of making a touch panel becomes very simple because the fingerprint identification area is set as an area for time-division multiplexing of fingerprint identification and touch operation, and the fingerprint identification area and the touch area are arranged at the same layer.

The present disclosure provides a method for detecting a contact on a touch panel. The touch panel includes a touch layer that comprises a fingerprint identification area. A first switch coupled to a first signal receiving terminal is disconnected when the first signal receiving terminal in the fingerprint identification area receives high voltage/low voltage output by a first input terminal. The fingerprint identification area receives a fingerprint identification signal output by a second input terminal. The fingerprint identification area is configured to identify a fingerprint pattern. The first switch coupled to the first signal receiving terminal turns off when the first signal receiving terminal in the fingerprint identification area receives the low voltage/the high voltage output by the first input terminal. The fingerprint identification area receives a touch signal output by a third input terminal. The fingerprint identification area is configured to identify a touch operation. The process of fabricating a touch panel becomes very simple because the fingerprint identification area is set as an area for time-division multiplexing of fingerprint identification and touch operation, and the fingerprint identification area and the touch area are arranged at the same layer. The fingerprint identification area is disposed in the same layer as the touch area, which simplifies the process of manufacturing the touch panel, saves production cost, and reduces the thickness of the display device.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

What is claimed is:

1. A method for detecting a contact on a touch panel, comprising:
providing the touch panel comprising a touch layer that comprises a fingerprint identification area;
disconnecting a first switch coupled to a first signal receiving terminal when the first signal receiving terminal in the fingerprint identification area receives high voltage/low voltage output by a first input terminal; the fingerprint identification area receiving a fingerprint identification signal output by a second input terminal; the fingerprint identification area configured to identify a fingerprint pattern;
turning the first switch coupled to the first signal receiving terminal off when the first signal receiving terminal in the fingerprint identification area receives the low voltage/the high voltage output by the first input terminal; the fingerprint identification area receiving a touch signal output by a third input terminal; the fingerprint identification area configured to identify a touch operation.

2. The method of claim 1, wherein the fingerprint identification further comprises first-array signal lines configured to acquire a capacitive value of each capacitive dot array in the fingerprint identification area to obtain a minutiae of a fingerprint pattern, or
the first-array signal lines configured to acquire the capacitive value of each of the capacitive dot arrays in the fingerprint identification area and variation of the capacitive value to obtain a touch location.

3. The method of claim 2, wherein the touch layer comprises a touch area that comprises second-array signal lines configured to acquire the capacitive value of each of the capacitive dot arrays in the touch area and the variation of the capacitive value to obtain the touch location.

4. The method of claim 1, wherein the touch panel further comprises a second signal receiving terminal, a fourth input terminal, and a second switch;
the second switch coupled to the second signal receiving terminal is turned off when the second signal receiving terminal in the fingerprint identification area receives high voltage/low voltage output by the fourth input terminal; the fingerprint identification area receives a touch signal output by a third input terminal; the fingerprint identification area is configured to identify a touch operation;
the second switch coupled to the second signal receiving terminal is disconnected when the second signal receiving terminal in the fingerprint identification area receives the low voltage/the high voltage output by the fourth input terminal; the fingerprint identification area receives a fingerprint identification signal output by the second input terminal; the fingerprint identification area is configured to identify the fingerprint pattern.

5. A touch panel, comprising a touch layer; the touch layer comprising a fingerprint identification area and a touch area;
the fingerprint identification comprises first-array signal lines; the first-array signal lines are configured to acquire a capacitive value of each capacitive dot array in the fingerprint identification area to obtain a minutiae of a fingerprint pattern; or
the first-array signal lines are configured to acquire the capacitive value of each of the capacitive dot arrays in the fingerprint identification area and variation of the capacitive value to obtain a touch location;
the touch area comprises second-array signal lines; the second-array signal lines are configured to acquire the capacitive value of each of the capacitive dot arrays in the touch area and the variation of the capacitive value to obtain the touch location.

6. The touch panel of claim 5, wherein the touch panel further comprises a second signal receiving terminal, a fourth input terminal, and a second switch;
the second switch coupled to the second signal receiving terminal is turned off when the second signal receiving terminal in the fingerprint identification area receives high voltage/low voltage output by the fourth input terminal; the fingerprint identification area receives a touch signal output by a third input terminal; the fingerprint identification area is configured to identify a touch operation;
the second switch coupled to the second signal receiving terminal is disconnected when the second signal receiving terminal in the fingerprint identification area receives the low voltage/the high voltage output by the fourth input terminal; the fingerprint identification area receives a fingerprint identification signal output by the second input terminal; the fingerprint identification area is configured to identify the fingerprint pattern.

7. The touch panel of claim 5, wherein the fingerprint identification area may be shaped as a circle, a square, a rectangle, or an ellipse.

8. The touch panel of claim 5, wherein the fingerprint identification area comprises a first electrode block; the first electrode block is configured to identify the fingerprint pattern; the first electrode block is configured to acquire the capacitive value of each of the capacitive dot arrays in the fingerprint identification area to obtain the minutiae of the fingerprint pattern or the touch location;
the touch area comprises a second electrode block; the second electrode block is configured to acquire the capacitive value of each of the capacitive dot arrays in the touch area and the variation of the capacitive value to obtain the touch location;
the first electrode block corresponds to one or more pixel opening; the area occupied by the second electrode block is greater than the area occupied by the first electrode block;
the first electrode block and the second electrode block are both transparent electrodes.

9. The touch panel of claim 5, wherein the ratio of the touch area to the fingerprint identification area is n; the n is greater than zero.

10. A touch panel, comprising a touch layer; the touch layer comprising a fingerprint identification area and a touch area;
the fingerprint identification comprises first-array signal lines; the first-array signal lines are configured to acquire a capacitive value of each capacitive dot array in the fingerprint identification area to obtain a minutiae of a fingerprint pattern; or
the first-array signal lines are configured to acquire the capacitive value of each of the capacitive dot arrays in the fingerprint identification area and variation of the capacitive value to obtain a touch location;
the touch area comprises second-array signal lines; the second-array signal lines are configured to acquire the capacitive value of each of the capacitive dot arrays in the touch area and the variation of the capacitive value to obtain the touch location;
wherein a density of the first array lines are greater than a density of the second-array signal lines.

11. The touch panel of claim 10, wherein the touch panel further comprises a second signal receiving terminal, a fourth input terminal, and a second switch;
the second switch coupled to the second signal receiving terminal is turned off when the second signal receiving terminal in the fingerprint identification area receives high voltage/low voltage output by the fourth input terminal; the fingerprint identification area receives a touch signal output by a third input terminal; the fingerprint identification area is configured to identify a touch operation;
the second switch coupled to the second signal receiving terminal is disconnected when the second signal receiving terminal in the fingerprint identification area receives the low voltage/the high voltage output by the fourth input terminal; the fingerprint identification area receives a fingerprint identification signal output by the second input terminal; the fingerprint identification area is configured to identify the fingerprint pattern.

12. The touch panel of claim 10, wherein the fingerprint identification area may be shaped as a circle, a square, a rectangle, or an ellipse.

13. The touch panel of claim 10, wherein the fingerprint identification area comprises a first electrode block; the first electrode block is configured to identify the fingerprint pattern; the first electrode block is configured to acquire the capacitive value of each of the capacitive dot arrays in the fingerprint identification area to obtain the minutiae of the fingerprint pattern or the touch location;
the touch area comprises a second electrode block; the second electrode block is configured to acquire the capacitive value of each of the capacitive dot arrays in the touch area and the variation of the capacitive value to obtain the touch location;
the first electrode block corresponds to one or more pixel opening; the area occupied by the second electrode block is greater than the area occupied by the first electrode block;
the first electrode block and the second electrode block are both transparent electrodes.

14. The touch panel of claim 10, wherein the ratio of the touch area to the fingerprint identification area is n; the n is greater than zero.
